(19) United States
(12) Patent Application Publication
(10) Pub. No.: US 2017/0005379 A1
(43) Pub. Date: Jan. 5, 2017

(54) METHODS, SYSTEMS AND APPARATUS FOR BATTERY WITH THERMAL TRANSFER LAYER

(71) Applicant: Hong Michael Dang, San Jose, CA (US)

(72) Inventor: Hong Michael Dang, San Jose, CA (US)

(21) Appl. No.: 14/868,388

(22) Filed: Sep. 29, 2015

Related U.S. Application Data
(60) Provisional application No. 62/187,203, filed on Jun. 30, 2015.

(51) Int. Cl. H01M 10/6551; H01M 2/12; H01M 2/02; H01M 10/6557; H01M 10/6561; H01M 10/613; H01M 10/6555

(52) U.S. Cl. CPC H01M 10/6551; H01M 10/613; H01M 2/12; H01M 10/6555; H01M 10/6557; H01M 10/6561; H01M 2/0217; H01M 2/022; H01M 2/024

(57) ABSTRACT

A battery comprising a thermal transfer layer having a plurality of dimples.

### TECHNICAL FIELD

The disclosed technology is related to thermal reduction in a battery.

### BACKGROUND

Unless otherwise indicated herein, the approaches described in this section are not prior art to the claims in this application and are not admitted to be prior art by inclusion in this section.

Batteries are very important and useful in almost every facet of modern day life. Batteries are found in virtually every electronic and/or otherwise powered device available including mobile phone, laptops, tablets, slate devices, radios, clocks, cars, medical devices and the like.

A problem with batteries is that they lose power over time and either have to be recharged or discarded and replaced when depleted. Batteries generate heat during operation which is not only a safety concern but also causes the battery to operate inefficiently and lose power through heat loss. For example, each 8° C. (15° F.) rise in temperature cuts the life of a sealed lead acid battery in half. Other factors such as frequent discharge can also have a negative impact on battery life.

### SUMMARY

Described herein are various illustrative methods, systems and apparatus for heat reduction in a battery.

In one example, a battery may comprise, a thermal transfer layer having a plurality of dimples. In an example, the thermal transfer layer comprises a casing layer encasing at least a portion of the battery on an outside surface. The battery may further include a vented housing configured to house the battery and allow airflow over at least a portion of the outside surface having the plurality of dimples. In some examples, the thermal transfer layer comprises a casing layer encasing at least a portion of an outside surface of one or more battery cells of the battery. In another example, the battery may include a vented housing configured to house one or more cells of the battery and allow airflow over at least a portion of the at least a portion of the outside surface of the one or more cells. Such battery may further comprise one or more battery cells including a substantially non-dimpled outside surface. Furthermore such substantially non-dimpled battery cells may be disposed proximate an air intake vent where as the one or more battery cells comprising the thermal transfer layer may be disposed proximate an air outlet vent of housing for battery. In an example, the thermal transfer layer may comprise copper, tungsten, zinc, graphite, graphene, cubic boron arsenide, diamond and/or phase change material.

In another example a battery may comprise a housing and an array of battery cells disposed within the housing where the housing comprises a casing including a first thermal transfer layer having a plurality of dimples. Battery may comprise at least one heat pipe coupled to at least one battery cell. The heat pipe may be threaded between a plurality of battery cells of the array. The heat pipe may comprise a plate and or tubing. The heat pipe may comprise a first vapor chamber wherein the casing comprises a second vapor chamber and wherein the first vapor chamber is coupled to the second vapor chamber permitting passage of vapor from the first vapor chamber to the second vapor chamber and vice versa. One example, the heat pipe comprises a second thermal transfer layer including a plurality of dimples on an outside surface of the heat pipe. The heat pipe may further comprises a second thermal transfer layer including a plurality of dimples on an inside surface of the heat pipe such that the second thermal transfer layer is configured to come into contact with vapor in the first vapor chamber. The thermal transfer layer may comprise at least one of copper, tungsten, zinc, graphite, graphene, cubic boron arsenide, diamond, or a phase change material.

In a further example, a battery may comprise a housing including a casing, an array of battery cells disposed within the housing, wherein one or more of the battery cells comprise a thermal transfer layer comprising a plurality of dimples and a heat pipe threaded among the array battery cells. In an example, the thermal transfer layer comprises at least one of copper, tungsten, zinc, graphite, graphene, cubic boron arsenide, diamond, or a phase change material.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several example embodiments in accordance with the disclosure and are, therefore, not to be considered limiting of its scope, the disclosure will be described with additional specificity and detail through use of the accompanying drawings.

In the drawings:

FIG. 1 illustrates an example of a lead acid battery comprising a thermal transfer layer on an outside surface.

FIG. 2 illustrates an example of a lithium ion battery comprising a thermal transfer layer on an outside surface.

FIG. 3 illustrates an example of a cutaway view of a battery having an array of battery cells each including a thermal transfer layer comprising a plurality of dimples.

FIG. 4 illustrates an example of a battery cell comprising a casing having a thermal transfer layer on a portion of an outside surface of the battery.

FIG. 5 illustrates an example of a cutaway view of a battery having an array of battery cells, a portion of which comprise a thermal transfer layer on an outer surface of the battery cells wherein the thermal transfer layer includes a plurality of dimples.

FIG. 6 illustrates an example of a battery comprising a plurality of battery cells and one or more heat pipes coupled to the battery cells and coupled to a thermal transfer layer comprising a plurality of dimples.

FIG. 6A illustrates an example of a cutaway view of a junction between a heat pipe and thermal transfer layer.

FIG. 7 illustrates an example of a battery comprising a plurality of battery cells and one or more heat pipes coupled to the battery cells and coupled to a thermal transfer layer comprising a plurality of dimples.

FIG. 7A illustrates an example of a cutaway view of a junction between a heat pipe and thermal transfer layer.

FIG. 8 illustrates an example of a battery comprising a plurality of battery cells and one or more heat pipes coupled to the battery cells and coupled to a thermal transfer layer comprising a plurality of dimples.

FIG. 8A illustrates an example of a cutaway view of a junction between a heat pipe and thermal transfer layer.

FIG. 9 illustrates an example of a battery comprising a plurality of battery cells and one or more heat pipes coupled to the battery cells and coupled to a thermal transfer layer comprising a plurality of dimples.

FIG. 9A illustrates an example of a cutaway view of a junction between a heat pipe and thermal transfer layer.

### DETAILED DESCRIPTION

The following description sets forth various examples along with specific details to provide a thorough understanding of claimed subject matter. It will be understood by those skilled in the art, however that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure. This disclosure is drawn, inter alia, to methods, apparatus, and systems related to thermal reduction in a battery.

Reducing the temperature of batteries while in operation can dramatically increase battery life. In an example, a battery having an outside surface covered with a plurality of dimples and exposed to air flow may more effectively transfer heat from the battery to the ambient air than a battery having an outside surface that is substantially smooth. This is due do to the fluid dynamic effects of airflow over the dimpled surface.

In an example, it may be advantageous to maintain a temperature of a plurality of battery cells at a substantially similar temperature so that the battery life of all battery cells in the plurality deteriorates at a similar rate. In an example, a battery having a plurality of cells encased in a housing that permits airflow over at least a portion of the plurality of cells may comprise a first portion of the cells having a substantially smooth exterior surface and a plurality of the cells having a dimpled exterior surface. The plurality of cells having the smooth exterior surface may be focused closer to air vents in the housing permitting the airflow over the plurality of cells and the plurality of cells having the dimpled exterior surface may be disposed in a position distal to the air vents. In this way, air may flow over the cells having the smooth exterior surface first removing heat and then may move over the plurality of cells having the dimpled exterior surface. Because the heat is more efficiently removed from the cells having the dimpled exterior surface air warmed by removing heat from the plurality of cells smooth exterior surface a cell efficiently repeat from the pole exterior surfaces. Accordingly, all of the cells in the battery maybe maintained at a more similar temperature than all the cells the same exterior surfaces.

In an example, it may be advantageous to provide a battery comprising a layer of highly thermally conductive material such as copper, tungsten, zinc, graphite, graphene, cubic boron arsenide, diamond, or a phase change material or any combination thereof wherein the layer of highly thermally conductive material is disposed in a serpentine path through various components of the battery, for example, battery cells. In an example, the layer may comprise a heat pipe having a dimpled interior service configured to move the contents of the heat pipe more efficiently through the heated end of the heat pipe and move heat more efficiently from the heated end of the heat pipe to the cooling end of the heat pipe. In an example, the heat pipe may be coupled to a thermal transfer layer comprising a plurality of dimples. Such coupling of the thermal transfer layer to the heat pipe may promote heat transfer from the heated or the heating end.

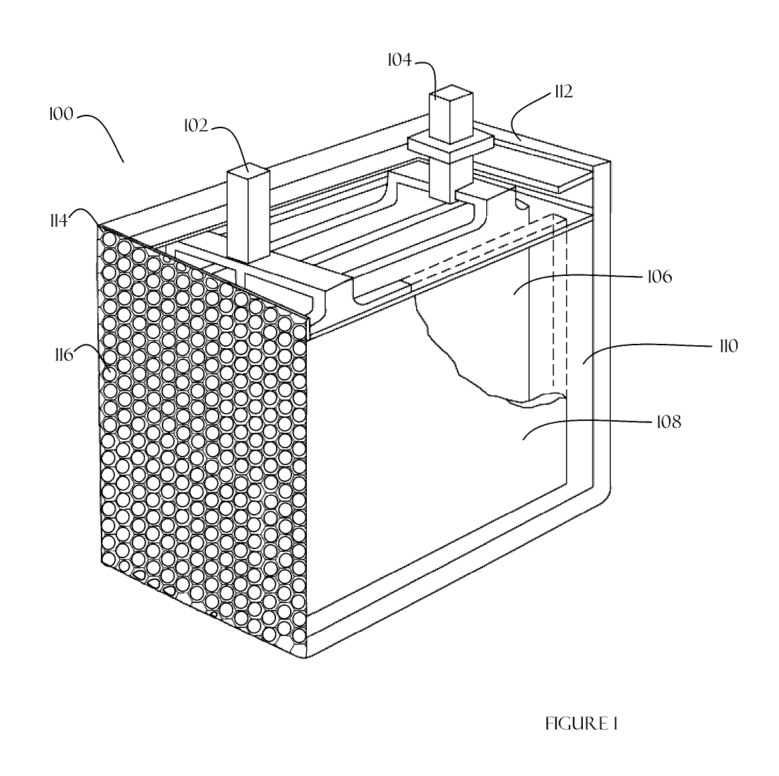

FIG. 1 illustrates an example of a lead acid battery including a thermal transfer layer comprising a plurality of dimples. In an example, battery 100 may include a positive electrode 102, a negative electrode 104, at least one cathode plate 106 and at least one anode plate 108. One or more cathode plates 106 and anode plates 108 may be submerged in an electrolyte solution 110. Electrolyte solution 110, cathode plate 106 and anode plate 108 are contained by a casing 112. Casing 112 includes a thermal transfer layer 114 having a plurality of dimples 116. Casing 112 may include one or more layers of material other than thermal transfer layer 114. In an example, casing 112 and/or thermal transfer layer 114 may comprise materials having a high thermal conductivity. For example, casing 112 and/or thermal transfer layer 114 may comprise compounds including copper, tungsten, zinc, graphite, graphene, cubic boron arsenide, diamond, or a phase change material or the like or any combinations thereof.

In an example, thermal transfer layer 114 can cover substantially all of an outside surface of casing 112. Alternatively, thermal transfer layer 114 may be disposed on only a portion of an outside surface of casing 112. In an example, dimples 116 may have a variety of radii and/or depths.

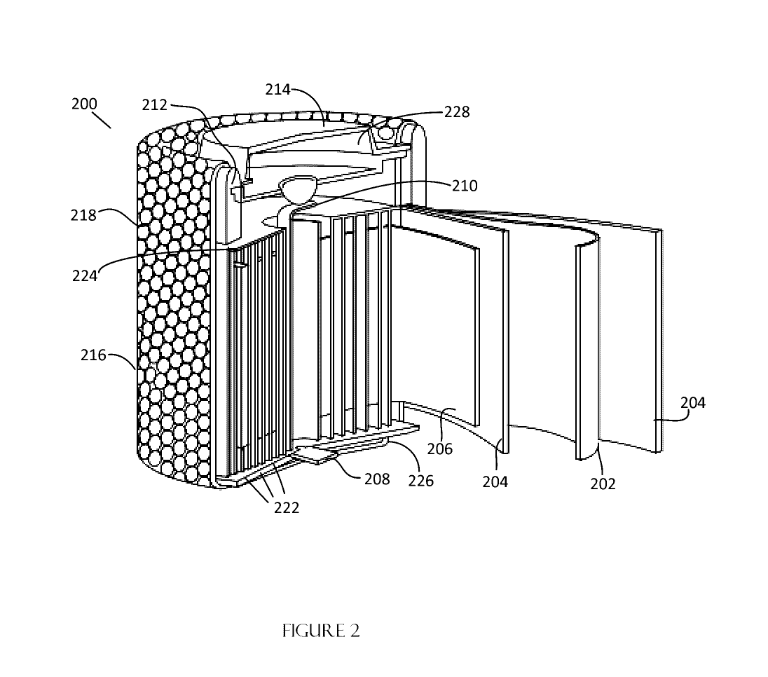

FIG. 2 illustrates an example of a lithium ion battery cell including a thermal transfer layer comprising a plurality of dimples. In an example, battery cell 200 may include layers comprising one or more of: an anode 202, a separator 204, and/or a cathode 206. Battery cell 200 may further comprise one or more of: a negative tab 208, a positive tab 210, an insulating ring 212, a top insulator 224, a bottom insulator 226, a cover 214, a vent 228 and/or a case 216. In an example, battery cell 200 may comprise several layers of alternating anode 202, separator 204 and cathode 206 layers. Case 216 can include a thermal transfer layer 218 having a plurality of dimples 220. Case 216 may include one or more layers of material other than thermal transfer layer 218. In an example, case 216 and/or thermal transfer layer 218 may comprise materials having a high thermal conductivity. For example, case 216 and/or thermal transfer layer 218 may comprise compounds including copper, tungsten, zinc, graphite, graphene, cubic boron arsenide, diamond, or a phase change material or the like or any combinations thereof.

In an example, thermal transfer layer 218 can cover substantially all of an outside surface of case 216. Alternatively, thermal transfer layer 218 may be disposed on only a portion of an outside surface of case 216. In an example, dimples 220 may have a variety of radii and/or depths.

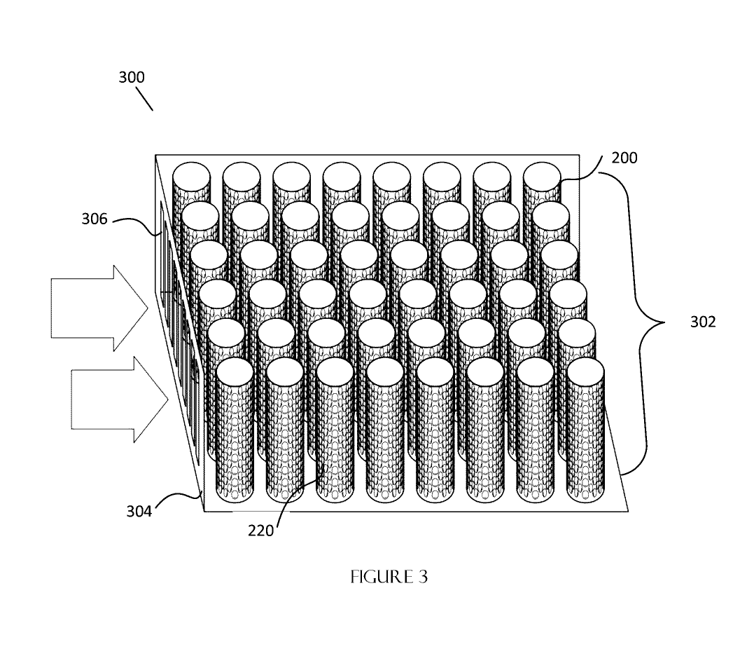

FIG. 3 illustrates an example of a cutaway view of a battery having an array of battery cells each including a thermal transfer layer comprising a plurality of dimples. Battery 300 may comprise an array 302 of battery cells 200 and a housing 304. In an example, housing 304 may comprise air intake vents 306 allowing air to flow over and/or around a plurality of battery cells 200 of array 302. A second set of air intake vents 306 may be disposed on a back wall (not shown) of battery 300 to enable airflow through housing 304 to enable airflow over dimples 220 of battery cells 200. Thus, heat generated by battery cells 200 during operation may be transferred from battery cells 200 to air flowing through housing 304 via intake vents 306 on a front and a back wall of housing 304. In an example, battery cells 200 may be uniformly covered in thermal transfer layer 218.

In another example battery cells 200 may comprise only a portion of an outside surface including thermal transfer layer 218.

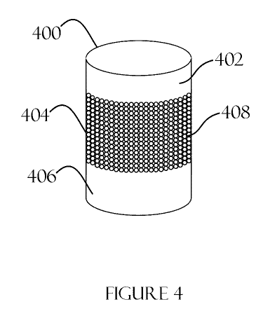

FIG. 4 illustrates an example of a battery cell comprising a casing having a thermal transfer layer on a portion of an outside surface of the battery. In an example, battery cell 400 may comprise an outer casing 402 comprising a thermal transfer layer 404. Thermal transfer layer 404 may cover only a portion of an outer surface 406 of battery cell 400. Thus, outer casing layer 402 may include an outer surface 406 that is substantially smooth a portion and in another portion may comprise thermal transfer layer 404 having a plurality of dimples 408. Battery cell 404 may be incorporated into an array of battery cells within a battery arrangement having a housing and air vents to enable airflow across battery cells 400 similar to that described in FIG. 3.

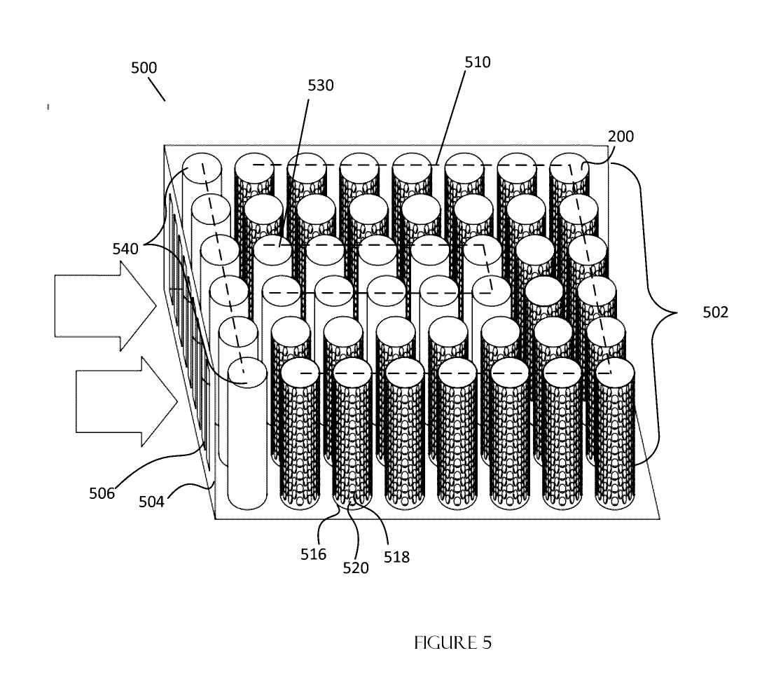

FIG. 5 illustrates an example of a cutaway view of a battery having an array of battery cells, a portion of which comprise a thermal transfer layer on an outer surface of the battery cells wherein the thermal transfer layer includes a plurality of dimples. In an example, in battery 500 air may flow over battery cells 200 through vent 506 and air outlet vents on an opposite wall of battery 500 (not shown). In testing, during operation battery cells 200 closer to front air intake vents 506 and in a middle portion of array 502 tend to be cooler than battery cells 200 on a periphery 510 of housing 504 while air is flowing over array 502. This may be due to convection and/or because as air absorbs thermal energy from battery cells 200 of array 502, the air warms and is less effective at cooling battery cells further out along periphery 510 of housing 504.

It may be desirable for a majority of battery cells 200 of array 502 to operate at substantially similar temperatures to enable battery 500 to operate more efficiently. Maintaining similar temperatures of battery cells 200 may enable uniformity in the operational life of battery cells 200 due to deleterious effects of heat on the operational life of battery cells.

In an example, in order to maintain similar temperatures of battery cells 200 of array 502, some battery cells 200 of array 502 may comprise a casing 516 having a thermal transfer layer 518 that includes a plurality of dimples 520 while other battery cells of array 502 may not comprise a thermal transfer layer 518. For example, front most 528 battery cells 200 and middlemost 530 battery cells 200 may comprise a smooth outer surface and/or be free of a dimpled thermal transfer layer 518 while battery cells 200 on periphery 510 may comprise a casing 516 having a thermal transfer layer 518 comprising dimples 520. In an example, array 502 may comprise one or more columns and/or rows of battery cells 200 comprising thermal transfer layer 518. In this way, air may enter air intake vents 506 and as the air is warmed the warmer air may flow over battery cells 200 having thermal transfer layer 518 and may cool battery cells 200 with or without thermal transfer layer 518 at a similar rate. In an example, any of battery cells 200 may comprise a casing 516 including a portion having a smooth surface and a portion having thermal transfer layer 518.

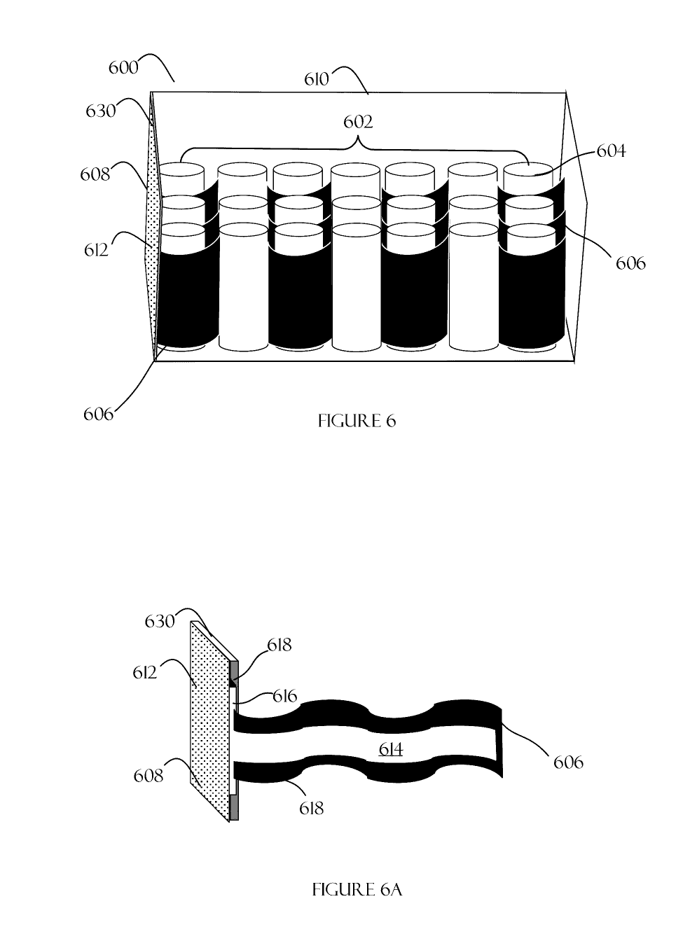

FIGS. 6, 6A, 7, 7A, 8, 8A, 9, and 9A describe various examples of battery cell arrangements in batteries comprising heat pipes threaded through an array of battery cells. Various other arrangements and combinations of described components are possible and contemplated and fall within the scope of the subject matter described herein. Likewise, it is contemplated that arrangements described in FIGS. 1-5 may also be incorporated with various arrangements described in and/or contemplated by FIGS. 6, 6A, 7, 7A, 8, 8A, 9, and 9A and also fall within the scope of the subject matter described herein.

FIG. 6 illustrates an example of a battery comprising a plurality of battery cells and one or more heat pipes coupled to the battery cells and coupled to a thermal transfer layer comprising a plurality of dimples. In an example, battery 600 may comprise a housing having a casing 630 and an array 602 of battery cells 604. The array 602 may have one or more heat pipes 606 threaded between battery cells 604. Heat pipes 606 may be in contact with the battery cells 604 and may be configured to carry heat away from the battery cells 604. Heat pipes 606 may comprise plates and/or tubing. Where heat pipes 606 comprise tubing a plurality of tubes maybe threaded in a weaved pattern through array 602 of battery cells 604. Heat pipes 606 may be coupled to a thermal transfer layer 608 of casing 630. Thermal transfer layer 608 may comprise a plurality of dimples 612. Dimples 612 of thermal transfer layer 608 may be exposed on an outer surface of casing 630 of battery housing 610. In an example, dimples 612 may cover a portion or the whole of an outer surface of housing 610.

FIG. 6A, illustrates an example of a cutaway view of casing 630 showing a junction between a heat pipe 606 and thermal transfer layer 608. Vapor chamber 614 of heat pipe 606 is in communication with vapor chamber 616 of thermal transfer layer 608. Thus, in an example, vapor trapped in vapor chamber 614 may travel toward lower temperature vapor chamber 616 where vapor may be condensed and reabsorbed by wick 618 to travel back to a region of higher temperature near battery cells 606. In an example, vapor chamber 616 may be cooler than vapor chamber 614 due to its distance from heat sources battery cells 606 as well as cooling effects of the dimpled surface of thermal transfer layer 608. Thermal transfer layer 608 may be in contact with airflow increasing the effectiveness of cooling by dimples 612. Wick 618 may be disposed in both thermal transfer layer 608 in communication with vapor chamber 616 as well as being in communication with vapor chamber 614.

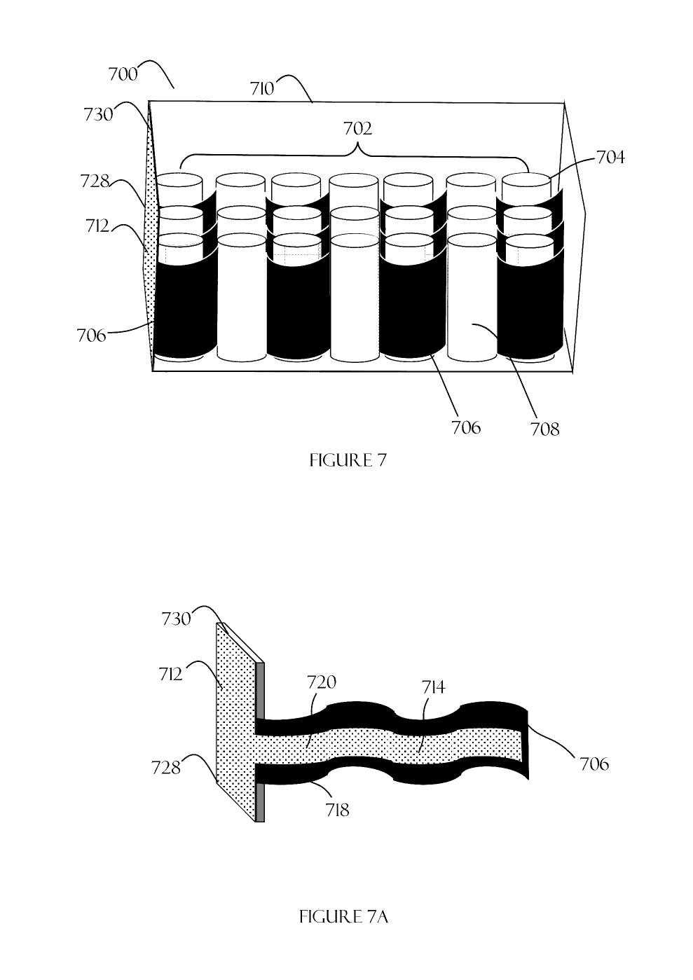

FIG. 7 illustrates an example of a battery comprising a plurality of battery cells and one or more heat pipes coupled to the battery cells and coupled to a thermal transfer layer comprising a plurality of dimples. In an example, battery 700 may comprise a housing 710 including a casing 730 housing an array 702 of battery cells 704. The array 702 may have one or more heat pipes 706 threaded between battery cells 704. One or more of battery cells 704 may comprise thermal transfer layer 708 on an outside surface of battery cells 704. Heat pipes 706 may be in contact with the battery cells 704 and may be configured to carry heat away from the battery cells 704. Heat pipes 706 may be coupled to a thermal transfer layer 728. Thermal transfer layer 708 may comprise a plurality of dimples 712. Thermal transfer layer 728 may be disposed in casing 730 wherein dimples 712 may be exposed on an outer surface of housing 710 of battery 700. In an example, dimples 712 may cover a portion or the whole of an outer surface of housing 710.

FIG. 7A, illustrates an example of a cutaway view of casing 730 showing a junction between a heat pipe 706 and thermal transfer layer 728. Vapor chamber 714 of heat pipe 706 may comprise a thermal transfer layer 720 comprising a plurality of dimples on an inner surface of vapor chamber 714. Thermal transfer layer 720 may be configured to enable heat transfer from liquid in wick 718 as vapor travels across the inner surface of vapor chamber 714 to lower temperature thermal transfer layer 728. In an example, thermal transfer layer 720 may be physically coupled to thermal transfer layer 728. Thermal transfer layer 728 may not comprise a vapor chamber separate from vapor chamber 714. A junction between thermal transfer layer 720 and thermal transfer layer 728 may transfer heat from vapor chamber 714 to thermal transfer layer 728 to be dissipate to outside airflow.

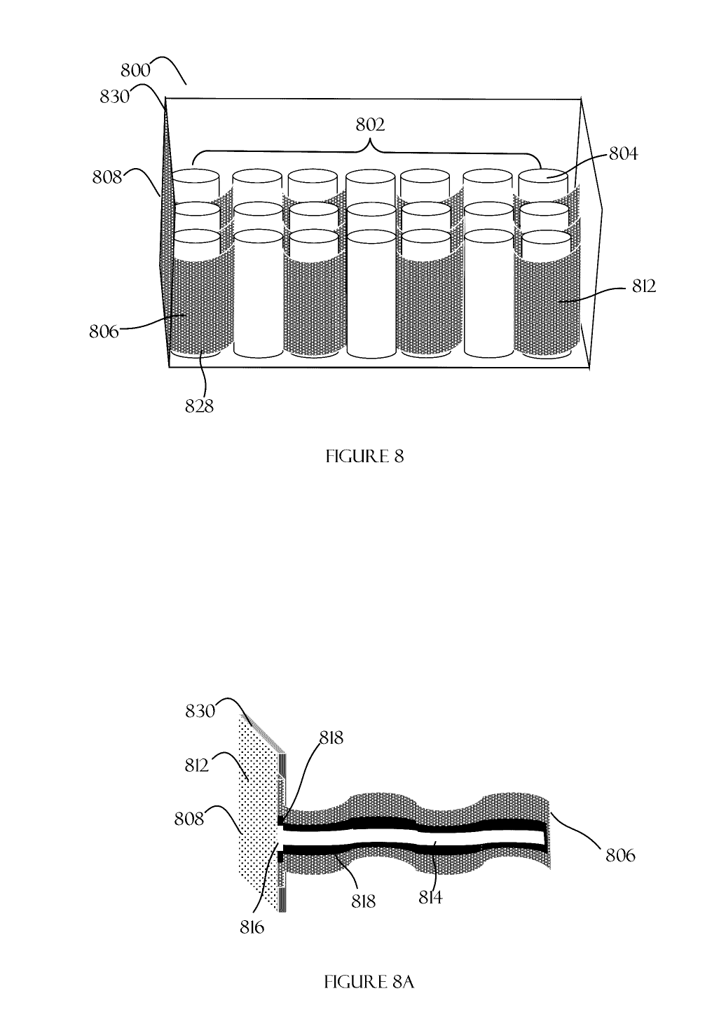

FIG. 8 illustrates an example of a battery comprising a plurality of battery cells and one or more heat pipes coupled to the battery cells and coupled to a thermal transfer layer comprising a plurality of dimples. In an example, battery 800 including a housing 810 having a casing layer 830 and may comprise an array 802 of battery cells 804. The array 802 may have one or more heat pipes 806 threaded between battery cells 804. One or more of heat pipes 806 may comprise thermal transfer layer 828 on an outside surface of heat pipes 806. Heat pipes 806 may be in contact with the battery cells 804 and may be configured to carry heat away from the battery cells 804. Heat pipes 806 may be coupled to a thermal transfer layer 808. Thermal transfer layer 808 may be disposed on an outer surface of casing 830 of battery 800. Thermal transfer layers 808 and 828 may comprise a plurality of dimples 812. In an example, dimples 812 may cover a portion or the whole of an outer surface of housing 810. In another embodiment, casing 830 may not comprise a thermal transfer layer and heat may be transferred away from battery cells 804 by thermal transfer qualities of heat pipe 806.

FIG. 8A, illustrates an example of a cutaway view of casing 830 showing a junction between a heat pipe 806 and thermal transfer layer 808. Vapor chamber 814 of heat pipe 806 is in communication with vapor chamber 816 of thermal transfer layer 808. Vapor trapped in vapor chamber 814 may travel toward lower temperature vapor chamber 816 where vapor may be condensed and reabsorbed by wick 818 to travel back to a region of higher temperature near battery cells 806 (see FIG. 8). In an example, vapor chamber 816 may be cooler than vapor chamber 814 due to its distance from heat sources, battery cells 806, as well as cooling effects of the dimpled surface of thermal transfer layer 808. Thermal transfer layer 808 may be in contact with airflow increasing the effectiveness of cooling by dimples 812. Wick 818 may be disposed in both thermal transfer layer 808 and heat pipe 806 in communication with vapor chamber 816 and with vapor chamber 814.

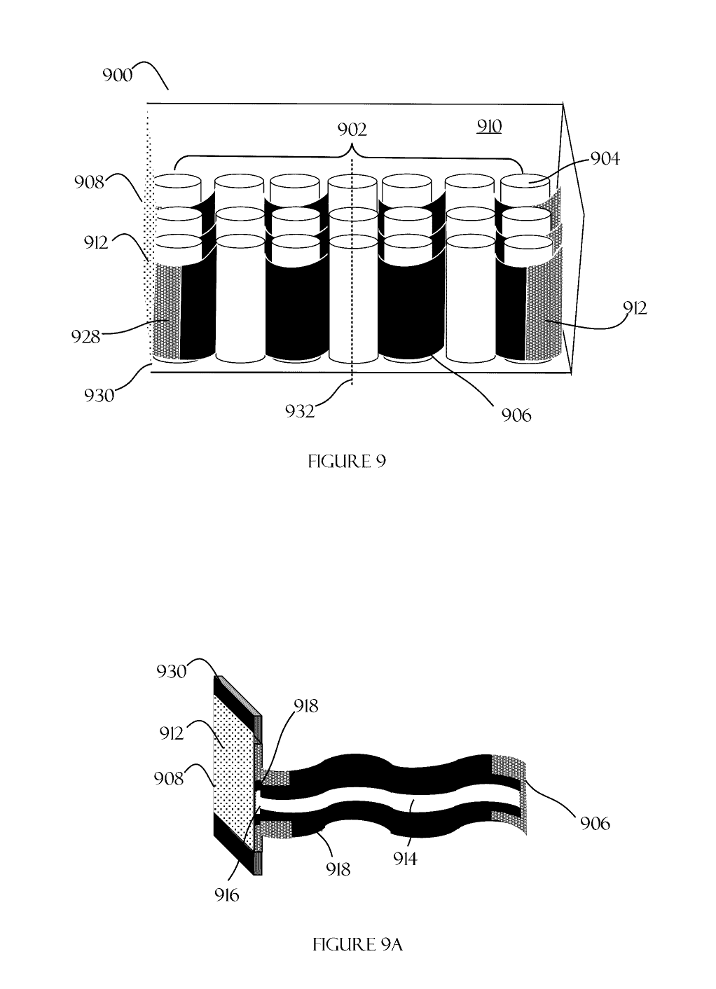

FIG. 9 illustrates an example of a battery comprising a plurality of battery cells and one or more heat pipes coupled to the battery cells and coupled to a thermal transfer layer comprising a plurality of dimples. In an example, battery 900 may comprise a housing 910 including casing 930 and an array 902 of battery cells 904. The array 902 may have one or more heat pipes 906 threaded between battery cells 904. One or more of heat pipes 906 may comprise thermal transfer layer 928 on one or more distal end portions of an outside surface of heat pipes 906. Thermal transfer layer 928 may be distal to a center portion 932 of heat pipes 906. Heat pipes 906 may be in contact with the battery cells 904 and may be configured to carry heat away from the battery cells 904. Heat pipes 906 may be coupled to thermal transfer layer 908 disposed on the outer surface of a battery housing 910. Thermal transfer layers 908 and 928 may comprise a plurality of dimples 912. In an example, dimples 912 may cover a portion or the whole of an outer surface of housing 910.

FIG. 9A, illustrates an example of a cutaway view of casing 930 a junction between a heat pipe 906 and thermal transfer layer 908. Vapor chamber 914 of heat pipe 906 is in communication with vapor chamber 916 of thermal transfer layer 908. Vapor trapped in vapor chamber 914 may travel toward lower temperature vapor chamber 916 where vapor may be condensed and reabsorbed by wick 918 to travel back to a region of higher temperature near battery cells 906 (see FIG. 9). In an example, vapor chamber 916 may be cooler than vapor chamber 914 due to its distance from heat sources, battery cells 906, as well as cooling effects of the dimpled surface of thermal transfer layer 908. Thermal transfer layer 908 may be in contact with airflow increasing the effectiveness of cooling by dimples 912. Wick 918 may be disposed in both thermal transfer layer 908 and heat pipe 906 in communication with vapor chamber 916 and with vapor chamber 914. Additionally, either and/or both ends of heat pipe 906 may be coupled with a thermal transfer layer in opposing walls of housing 910 (see FIG. 9).

Claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

The herein described subject matter sometimes illustrates an example of different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to technologies containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an example,” “one example,” “some examples,” or “other examples” may mean that a particular feature, structure, or characteristic described in connection with one or more examples may be included in at least some examples, but not necessarily in all examples. The various appearances of “an example,” “one example,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A battery comprising, a thermal transfer layer having a plurality of dimples.

2. The battery of claim 1, wherein the thermal transfer layer comprises a casing layer encasing at least a portion of the battery on an outside surface.

3. The battery of claim 2, further comprising:
a vented housing configured to house the battery and allow airflow over at least a portion of the outside surface having the plurality of dimples.

4. The battery of claim 1, wherein the thermal transfer layer comprises a casing layer encasing at least a portion of an outside surface of one or more battery cells of the battery.

5. The battery of claim 4, further comprising:
a vented housing configured to house one or more cells of the battery and allow airflow over at least a portion of the at least a portion of the outside surface of the one or more cells.

6. The battery of claim 5, further comprising one or more battery cells comprising a substantially non-dimpled outside surface.

7. The battery of claim 6, wherein the one or more battery cells comprising the substantially non-dimpled surface are disposed proximate an air intake vent and the one or more battery cells comprising the thermal transfer layer are disposed proximate an air outlet vent of the housing.

8. The battery of claim 7, wherein the thermal transfer layer comprises at least one of copper, tungsten, zinc, graphite, graphene, cubic boron arsenide, diamond, or a phase change material.

9. A battery comprising:
a housing; and
an array of battery cells disposed within the housing, wherein the housing comprises a casing including a first thermal transfer layer having a plurality of dimples.

10. The battery of claim 9, further comprising at least one heat pipe coupled to at least one battery cell.

11. The battery of claim 9, further comprising at least one heat pipe threaded between a plurality of the battery cells of the array.

12. The battery of claim 11, wherein the heat pipe is a plate.

13. The battery of claim 11, wherein the heat pipe comprises a plurality of tubes.

14. The battery of claim 11, wherein the heat pipe comprises a first vapor chamber and wherein the casing comprises a second vapor chamber and wherein the first vapor chamber is coupled to the second vapor chamber permitting passage of vapor from the first vapor chamber to the second vapor chamber and vice versa.

15. The battery of claim 14, wherein the heat pipe comprises a second thermal transfer layer including a plurality of dimples on an outside surface of the heat pipe.

16. The battery of claim 14, wherein the heat pipe comprises a second thermal transfer layer including a plurality of dimples on an inside surface of the heat pipe such that the second thermal transfer layer is configured to come into contact with vapor in the first vapor chamber.

17. The battery of claim 16, wherein the thermal transfer layer comprises at least one of copper, tungsten, zinc, graphite, graphene, cubic boron arsenide, diamond, or a phase change material.

18. A battery comprising:
a housing comprising a casing;
an array of battery cells disposed within the housing, wherein one or more of the battery cells comprise a thermal transfer layer comprising a plurality of dimples; and
a heat pipe threaded among the array battery cells.

19. The battery of claim 17, wherein the thermal transfer layer comprises at least one of copper, tungsten, zinc, graphite, graphene, cubic boron arsenide, diamond, or a phase change material.
